(19) United States
(12) Patent Application Publication
(10) Pub. No.: US 2016/0075594 A1
(43) Pub. Date: Mar. 17, 2016

(54) REFURBISHING A COMPONENT OF AN ELECTRONIC DEVICE

(71) Applicant: INNOVATIVE FINISHES LLC, Granby, CT (US)

(72) Inventor: Jeffrey J. Bliss, Granby, CT (US)

(21) Appl. No.: 14/786,708

(22) PCT Filed: Apr. 22, 2014
(86) PCT No.: PCT/US14/34993

§ 371 Date: Oct. 23, 2015

Related U.S. Application Data
(60) Provisional application No. 61/824,563, filed on May 17, 2013.

(51) Int. Cl. C03C 17/00; B05D 3/12

(52) U.S. Cl. CPC C03C 17/008; B05D 3/12; C03C 2217/445; C03C 2217/475

(57) ABSTRACT

A method of refurbishing a surface of a component for an electronic device, includes: abrading a surface to be refurbished with an abrasive to remove a coating on the surface and provide an abraded surface; optionally firstly cleaning the treated surface by contacting with a glass cleaner to provide a firstly cleaned surface; optionally secondly cleaning the firstly cleaned surface by contacting the firstly cleaned surface with a grease remover to provide a secondly cleaned surface; optionally contacting the firstly or the secondly cleaned surface with an activator to provide an activated surface; and disposing a coating resin on the treated and optionally activated surface; and curing the coating resin to provide a coated surface to refurbish the surface of the electronic device, wherein the coating resin comprises metal oxide nanoparticles comprising about 50% to about 99% by weight of an oxide of Groups 12 to 14, or a combination thereof.

### BACKGROUND

(1) Field

This disclosure relates to a refurbished component, an electronic device including the same, and method of refurbishing a component of an electronic device.

(2) Description of the Related Art

Electronic devices, such as cell phones or touch pads, can get scratched or worn in the course of use. Devices without visible scratches are desirable because they have higher resale value and are cosmetically attractive. Scratched or worn components can be replaced with new components. However, refurbishing is desirable to reduce cost and environmental impact. Thus there remains a need for a method of refurbishing device components to provide a suitable cosmetic appearance.

### SUMMARY

Disclosed is a method of refurbishing a surface, the method including: abrading a surface to be refurbished with an abrasive to remove a coating on the surface and provide an abraded surface; optionally firstly cleaning the abraded surface by contacting with a glass cleaner to provide a firstly cleaned surface; optionally secondly cleaning the firstly cleaned surface by contacting the firstly cleaned surface with a grease remover to provide a secondly cleaned surface; optionally contacting the firstly or the secondly cleaned surface with an activator to provide an activated surface; disposing a coating resin on the abraded and optionally activated surface; and curing the coating resin to provide a coated surface to refurbish the surface of the electronic device, wherein the coating resin includes metal oxide nanoparticles comprising about 50% to about 99% by weight of an oxide of Groups 12 to 14, or a combination thereof.

Alternatively, a method of refurbishing a surface including: contacting a surface to be refurbished with an etching composition to provide a treated surface; optionally firstly cleaning the treated surface by contacting with a glass cleaner to provide a firstly cleaned surface; optionally secondly cleaning the firstly cleaned surface by contacting the firstly cleaned surface with a grease remover to provide a secondly cleaned surface; optionally contacting the firstly or the secondly cleaned surface with an activator to provide an activated surface; disposing a coating resin on the treated and optionally activated surface; and curing the coating resin to provide a coated surface to refurbish the surface of the electronic device, wherein the coating resin comprises metal oxide nanoparticles comprising about 50% to about 99% by weight of an oxide of Groups 12 to 14, or a combination thereof.

Also disclosed is a refurbished component for an electronic device including: a glass surface; and a polymerization product of a coating resin comprising metal oxide nanoparticles disposed on the surface, wherein the metal oxide nanoparticles include about 50% to about 99% by weight of an oxide of a Groups 12 to 14, or a combination thereof.

Also disclosed is a refurbished electronic device, the electronic device including the refurbished component for the electronic device.

### DETAILED DESCRIPTION

The invention now will be described more fully hereinafter. This invention may be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

“Alkoxy” means an alkyl group that is linked via an oxygen (i.e., -O-alkyl). Nonlimiting examples of C1 to C30 alkoxy groups include methoxy groups, ethoxy groups, propoxy groups, isobutyloxy groups, sec-butyloxy groups, pentyloxy groups, iso-amyloxy groups, and hexyloxy groups.

“Alkyl” means a straight or branched chain saturated aliphatic hydrocarbon having the specified number of carbon atoms, specifically 1 to 12 carbon atoms, more specifically 1 to 6 carbon atoms.

“Aryl” means a cyclic moiety in which all ring members are carbon and at least one ring is aromatic, the moiety having the specified number of carbon atoms, specifically 6 to 24 carbon atoms, more specifically 6 to 12 carbon atoms. More than one ring may be present, and any additional rings may be independently aromatic, saturated or partially unsaturated, and may be fused, pendant, spirocyclic or a combination thereof.

“Halogen” means one of the elements of Group 17 of the periodic table (e.g., fluorine, chlorine, bromine, iodine, and astatine).

“Carboxyl” means a functional group consisting of a carbonyl and a hydroxyl, which has the formula —C(═O)OH.

A “surface to be refurbished” includes a damaged surface as well as undamaged surface.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

There is currently no technology, including buffing, which can remove deep scratches on the glass surfaces of device screens or digitizers. Further, buffing does not result in a cosmetically satisfactory product having a sufficiently scratch-free appearance and suitable luster. Also, modern wireless devices use high hardness glasses and/or coatings which make buffing difficult. In addition, clear coatings do not suitably adhere directly to device screens or digitizers, making it impractical to simply cover scratched surfaces with a clear coating.

After exploring different process and material variables, it has been surprisingly discovered that the scratched, worn and lack luster glass surfaces of device screens or digitizers can be refurbished conveniently in a cost-effective matter to provide a scratch-free and shiny new appearance using the method disclosed herein. In addition, the refurbished surface can have high scratch resistance, high chemical resistance, long-term weather resistance, and excellent gloss retention. Accordingly, by refurbishing electronic devices using the discovered method, the worn devices can have a cosmetically appealing new look, and also have a surface coating that is effective to provide long term protection to the device surface, thereby preserving the environment, conserving materials, minimizing pollution, and eliminating waste.

Disclosed is a method of refurbishing a surface, particularly a surface of a component of an electronic device, e.g., a surface of a wireless device screen or a digitizer, which provides a surface that is free of scratches or defects to the untrained and unaided eye, e.g., an eye of a consumer.

In an embodiment, the method comprises abrading a surface to be refurbished with an abrasive to remove a coating on the surface and provide an abraded surface; contacting the abraded surface with a coating resin; and curing the coating resin to provide a coated surface to refurbish the surface of the component of the electronic device.

The abrading may comprise abrading with a diamond polishing compound. The diamond polishing compound comprises diamond and a lubricant and/or a vehicle. The diamond may have a mesh of about 600 to about 2000 grit, specifically about 800 to about 1800 grit. A diamond polishing compound comprising 1200 grit diamond is specifically mentioned. In an embodiment the diamond has a maximum particle size of about 1 micrometer (μm) to about 15 μm, specifically about 2 μm to about 10 μm. Diamond having a maximum particle size of about 9 μm is specifically mentioned.

The abrading may comprise abrading with aluminum oxide particles having a size of about 5 to about 80 micrometers, for example, about 5 to about 30 micrometers, about 15 to about 45 micrometers, or about 30 to about 80 micrometers using an abrasive jet machining (“AJM”) system. The AJM system can operate at a pressure of about 0.5 bar to about 100 bar, specifically about 1 bar to 30 bar, more specifically about 3 bar to about 10 bar. The aluminum oxide particles are carried by air or an inert gas such as nitrogen and argon. An exemplary AJM system may be used is a micro-blaster.

In another embodiment, the method comprises contacting a surface to be refurbished with an etching composition to provide a treated surface; contacting the treated surface with a coating resin; and curing the coating resin to provide a coated surface to refurbish the surface of the component of the electronic device.

The contacting comprises applying an etching composition to the surface to be refurbished, allowing the etching composition to reside for about 2 seconds to about 30 minutes, about 5 seconds to about 20 minutes, about 5 seconds to about 15 minutes, about 5 seconds to about 10 minutes, then removing the etching composition and the coating. Contacting for about 20 seconds is specifically mentioned.

The etching composition can comprise a fluoride selected from sodium fluoride, potassium fluoride, ammonium fluoride, sodium bifluoride, potassium bifluoride, ammonium bifluoride, ammonium borofluoride, ammonium silicofluoride, or a combination thereof. The fluoride can be present in an amount of about 1 weight percent (wt %) to about 50 wt %, about 5 wt % to about 40 wt %, about 5 wt % to about 30 wt %, about 5 to about 20 wt %, about 10 wt % to about 50 wt %, or about 15 wt % to about 40 wt %, based on the total weight of the etching composition.

The etching composition can further comprise an acid selected from acetic acid, citric acid, malic acid, succinic acid, phosphoric acid, hydrochloric acid, sulfuric acid, nitric acid, hydrofluoric acid, or a combination thereof. The amount of the acid component can be about 0.1 wt % to about 20 wt %, about 0.5 wt % to about 15 wt %, from about 2 wt % to about 0.5 wt % to about 10 wt %, about 5 wt % to about 20 wt %, or about 5 wt % to about 15 wt %, based on the total weight of the etching composition.

The etching composition can be in any suitable form, and may be in the form of a paste, a cream, a gel, or a liquid.

The abrading or contacting with an etching composition may be sufficient to remove a coating on the surface to be refurbished. In an embodiment, the coating is an oleophilic coating. In another embodiment, the coating is an oleophobic coating.

As used herein, “removing a coating” includes the situation where a coating is partially removed. While not wanting to be bound by theory, it is understood that complete removal of the coating is desirable in some embodiments in order to provide a refurbished surface having suitable cosmetic properties, for example, a surface which is optically scratch free and has desirable luster.

After removing a coating, the abraded or treated surface may be optionally contacted with a glass cleaner to provide a firstly cleaned surface. The glass cleaner may comprise a solvent, a cleaning agent, a surfactant, a wetting agent, or a combination thereof. The glass cleaner may also comprise a fragrance or a dye. In a specific embodiment, the glass cleaner comprises water and acetic acid. In another embodiment, the glass cleaner comprises ammonium hydroxide instead of acetic acid. The glass cleaner can also comprises disodium cocoamphodipropionate, 2-hexoxyethanol, butoxypropanol, butoxyethanol, isopropyl alcohol, propylene glycol, sodium lauryl sulfate, ethoxylated alcohol, sodium C₁₄₋₁₇ sec-alkyl sulfonate, sodium laureth sulfate, lauryl glucoside, alkyl polyglycoside, sodium dodecylbenzene sulfonate, ethanol amine, or a combination thereof.

Also, the abraded or treated surface, which may optionally be firstly cleaned, may be further optionally contacted with a grease remover to provide a secondly cleaned surface. The grease remover may comprise a solvent effective to remove grease. Exemplary solvent includes acetone, an alcohol (e.g., methanol, ethanol, butanol); water; liquid carbon dioxide; an aldehyde (e.g., an acetaldehyde, a propionaldehyde), a formamide (e.g., N,N-dimethylformamide); a ketone (e.g., acetone, methyl ethyl ketone, β-bromoethyl isopropyl ketone); acetonitrile; a sulfoxide (e.g., dimethylsulfoxide, diphenylsulfoxide, ethyl phenyl sulfoxide); a sulfone (e.g., diethyl sulfone, phenyl 7-quinolylsulfone); a thiophene (e.g., thiophene 1-oxide); an acetate (e.g., ethylene glycol diacetate, n-hexyl acetate, 2-ethylhexyl acetate); an amide (e.g., propanamide, benzamide), or a combination thereof. In an embodiment, the grease remover comprises stoddard solvent such as mineral spirits, aliphatic petroleum distillates, white spirits; naphtha; heptane; toluene; or a combination thereof.

The abraded surface or treated surface, which may optionally be firstly cleaned and/or secondly cleaned, may be optionally contacted with an activator to provide an activated surface. While not wanting to be bound by theory, it is understood that the activator chemically reacts with the abraded surface to provide a functional group thereon to provide improved bonding properties with a coating layer. The activator may comprise an alcohol, e.g., methanol, ethanol, propanol, isopropanol, butanol, or a combination thereof, and/or a silane compound. In an embodiment, the activator comprises a carboxysilyl compound of the formula SiR₁R₂R₃R₄ wherein R₁ is a straight or branched chain substituted with a carboxyl group or a salt thereof, each R₂, R₃ and R₄ is independently a C1 to C12 alkoxy group, a C1 to C12 alkyl group, a C6 to C24 aryl group, halogen, or hydroxy. The phrase “straight or branched chain” as used herein means a C1 to C12 hydrocarbon optionally substituted with a heteroatom such as N on its backbone. An exemplary carboxysilyl compound is N-[(3-trimethoxysilyl)propyl]ethylene-diamine triacetic acid trisodium salt. The activator may comprise an activator as disclosed in U.S. Pat. No. 8,293,322, the content of which in its entirety is herein incorporated by reference, e.g., 2-oxo-N-(3-(triethoxysilyl)propyl)azepane-1-carboxamide. The activator may comprise a silica sol comprising a metal salt and a partial hydrolyzate of an alkoxysilane oligomer, wherein the metal salt is a metal organic acid salt or a metal carbonate of one or more of magnesium, calcium, strontium and barium, and wherein the alkoxysilane oligomer is tetraethoxysilane, tetrapropoxysilane, methyltriethoxysilane, dimethylmethoxysilane, phenyltriethoxysilane, chlorotrimethylsilane, vinyltriethoxysilane or aminopropyltriethoxysilane. Such activators are disclosed in European Patent Application EP1304399, the content of which in its entirety is herein incorporated by reference. In an embodiment, the activator may comprise an unsaturated-hydrocarbylamido-alkanesulfonic acid or a salt thereof, e.g., 2-acrylamido-2-methylpropanesulfonic acid or a salt thereof, as disclosed in European Patent EP 1560858, the content of which in its entirety is herein incorporated by reference. The activator may comprise an epoxysilane for example a gamma glycidoxy-propyl-trimethoxy-silane.

In an embodiment, the activator may also comprise a reaction product of an epoxy silane and an amino silane having at least two amine groups per molecule. The epoxy silane and amino silane are used in amounts such that the final mole ratio of epoxy silanes to amino silanes in the reaction mixture is about at least 2:1. Suitable epoxy silanes for use in preparing a reaction product with epoxy silane and amino silane include any compound containing at least one epoxy group and silane group per compound and include, for example, gamma-glycidoxypropyldimethylethoxy silane, gamma-glycidoxypropylmethyldiethoxy silane, gamma-glycidoxypropyltrimethoxy silane, glycidoxypropyltrimethoxy silane, beta-(3,4-epoxycyclohexyl)ethylmethyltrimethoxy silane, and beta-(3,4-epoxycyclohexyl)ethylmethyldimethoxy silane. Specifically mentioned is gamma-glycidoxypropyltrimethoxy silane. Suitable amino silanes include N-(beta-aminoethyl)aminomethyltrimethoxy silane, gamma-aminopropyltriethoxy silane, gamma-aminopropylmethyldiethoxy silane, N-(gamma-aminoethyl)-gamma-aminopropyltriethoxy silane, N-(gamma-aminoethyl)-gamma-methyldimethoxy silane, and trimethoxysilylpropyldiethylene triamine. N-beta-(aminoethyl)-gamma-aminopropyltrimethoxy silane is specifically mentioned. The activator may also comprise a film forming resin. Such activators are disclosed in U.S. Pat. No. 5,466,727, the content of which in its entirety is herein incorporated by reference.

The activator may be disposed by any suitable method, e.g., spraying, dipping, roll coating, brush coating, or transfer coating.

A coating resin is then disposed on the abraded or treated and optionally activated surface of the component. A wide variety of clear-coat formulations are known and can be used. However, particularly advantageous coating resins comprise metal oxide nanoparticles, wherein the nanoparticles comprise about 50% to 99% by weight of an oxide of Groups 12 to 14, or a combination thereof. In an embodiment, the oxide is an oxide of Zn, Al, Si, or a combination thereof. Zirconia, alumina, and silica are specifically mentioned. In an embodiment, the oxide of the metal oxide nanoparticles may further comprise a Group 2 element. Magnesium is specifically mentioned. In an embodiment, the metal oxide nanoparticles may comprise about 50% to about 99% by weight of aluminum oxide and about 0.1% to about 50% by weight of an oxide of Mg, Zn, Si, or a combination thereof. Magnesium aluminum oxide, e.g., MgO doped alumina, is specifically mentioned. The coating may provide exceptional properties, including suitable hardness, fast cure, and suitable buffability.

The metal oxide nanoparticles can be obtained by wet grinding in a solvent. If desired, the nanoparticles can be coated with a silane or a siloxane. Exemplary silanes and siloxanes include hexamethyldisiloxane, octamethyltrisiloxane, hexamethyl-cyclo-trisiloxane, octamethyl-cyclo-tetrasiloxane, dihydroxytetramethyldisiloxane, dihydroxyhexamethyltrisiloxane, dihydroxyoctamethyltetrasiloxane, α,ω-dihydroxypolysiloxanes, e.g., polydimethylsiloxane (OH end groups, 90-150 cST) or polydimethylsiloxane-co-diphenylsiloxane (dihydroxy end groups, 60 cST), dihydrohexamethyltrisiloxane, dihydrooctamethyltetrasiloxane, α,ω-dihydropolysiloxanes, e.g., polydimethylsiloxane (hydride end groups, Mn=580), di(hydroxypropyl)hexamethyltrisiloxane, di(hydroxypropyl)octamethyltetrasiloxane, triethoxysilane, octadecyltrimethoxysilane, 3-(trimethoxysilyl)propyl methacrylates, 3-(trimethoxysilyl)propyl acrylates, 3-(trimethoxysilyl)methyl methacrylates, 3-(trimethoxysilyl)methyl acrylates, 3-(trimethoxysilyl)ethyl methacrylates, 3-(trimethoxysilyl)ethyl acrylates, 3-(trimethoxysilyl)pentyl methacrylates, 3-(trimethoxysilyl)pentyl acrylates, 3-(trimethoxysilyl)hexyl methacrylates, 3-(trimethoxysilyl)hexyl acrylates, 3-(trimethoxysilyl)butyl methacrylates, 3-(trimethoxysilyl)butyl acrylates, 3-(trimethoxysilyl)heptyl methacrylates, 3-(trimethoxysilyl)heptyl acrylates, 3-(trimethoxysilyl)octyl methacrylates, 3-(trimethoxysilyl)octyl acrylates, methyltrimethoxysilanes, methyltriethoxysilanes, propyltrimethoxysilanes, propyltriethoxysilanes, isobutyltrimethoxysilanes, isobutyltriethoxysilanes, octyltrimethoxysilanes, octyltriethoxysilanes, hexadecyltrimethoxysilanes, phenyltrimethoxysilanes, phenyltriethoxysilanes, tridecafluoro-1,1,2,2-tetra-hydrooctyltriethoxysilanes, tetramethoxysilanes, tetraethoxysilanes, oligomeric tetraethoxysilanes, tetra-n-propoxysilanes, 3-glycidyloxypropyltrimethoxysilanes, 3-glycidyloxypropyltriethoxysilanes, 3-methacryloyloxypropyltrimethoxysilanes, vinyltrimethoxysilanes, vinyltriethoxysilanes, 3-mercaptopropyltrimethoxysilanes, 3-aminopropyltriethoxysilanes, 3-aminopropyltrimethoxysilanes, 2-aminoethyl-3-aminopropyltrimethoxysilanes, triamino-functional propyltrimethoxysilanes, N-(n-butyl)-3-aminopropyltrimethoxysilanes, 3-aminopropylmethyldiethoxysilanes, or a combination thereof.

The molar ratio of the metal oxide nanoparticles to the silane or the siloxane may be about 1:1 to about 10:1, about 1:2 to about 9:1, or about 1:3 to about 8:1.

The coating resin can further comprise a polymer, copolymer, terpolymer, or a combination comprising at least one of the foregoing polymers. The polymer, copolymer, terpolymer, or a combination can be an oligomer, a homopolymer, a copolymer, a block copolymer, an alternating block copolymer, a random polymer, a random copolymer, a random block copolymer, a graft copolymer, a star block copolymer, a dendrimer, or the like, or a combination thereof.

Examples of polymers which may be included in the coating resin include thermoplastic and thermosetting polymers such as polyacetals, polyolefins, polyacrylics, polyacrylates, polycarbonates, polystyrenes, polyesters, polyamides, polyamideimides, polyarylates, polyarylsulfones, polyethersulfones, polyphenylene sulfides, polyvinyl chlorides, polysulfones, polyimides, polyetherimides, polytetrafluoroethylenes, polyetherketones, polyether etherketones, polyether ketone ketones, polybenzoxazoles, polyphthalides, polyanhydrides, polyvinyl ethers, polyvinyl thioethers, polyvinyl alcohols, polyvinyl ketones, polyvinyl halides, polyvinyl nitriles, polyvinyl esters, polysulfonates, polysulfides, polythioesters, polysulfones, polysulfonamides, polyureas, polyphosphazenes, polysilazanes, polyethylene terephthalate, polybutylene terephthalate, polyurethanes, ethylene propylene diene rubber (EPR), polytetrafluoroethylene, fluorinated ethylene propylene, perfluoroalkoxyethylene, polychlorotrifluoroethylene, polyvinylidene fluoride, or a combination thereof.

The coating resin may further comprise a blend comprising thermoplastic polymers, and may include acrylonitrile-butadiene-styrene/nylon, polycarbonate/acrylonitrile-butadiene-styrene, acrylonitrile butadiene styrene/polyvinyl chloride, polyphenylene ether/polystyrene, polyphenylene ether/nylon, polysulfone/acrylonitrile-butadiene-styrene, polycarbonate/thermoplastic urethane, polycarbonate/polyethylene terephthalate, polycarbonate/polybutylene terephthalate, thermoplastic elastomer alloys, nylon/elastomers, polyester/elastomers, polyethylene terephthalate/polybutylene terephthalate, acetal/elastomer, styrene-maleicanhydride/acrylonitrile-butadiene-styrene, polyether etherketone/polyethersulfone, polyether etherketone/polyetherimide polyethylene/nylon, polyethylene/polyacetal, or the like, or a combination thereof.

In an embodiment, the coating resin may further comprise a polyacetal, polyacrylic, polycarbonate, polystyrene, polyester, polyamide, polyamideimide, polyarylate, polyarylsulfone, polyethersulfone, polyphenylene sulfide, polyvinyl chloride, polysulfone, polyimide, polyetherimide, polytetrafluoroethylene, polyetherketone, polyether etherketone, polyether ketone ketone, polybenzoxazole, polyoxadiazole, polybenzothiazinophenothiazine, polybenzothiazole, polypyrazinoquinoxaline, polypyromellitimide, polyquinoxaline, polybenzimidazole, polyoxindole, polyoxoisoindoline, polydioxoisoindoline, polytriazine, polypyridazine, polypiperazine, polypyridine, polypiperidine, polytriazole, polypyrazole, polypyrrolidine, polycarborane, polyoxabicyclononane, polydibenzofuran, polyphthalide, polyacetal, polyanhydride, polyvinyl ether, polyvinyl thioether, polyvinyl alcohol, polyvinyl ketone, polyvinyl halide, polyvinyl nitrile, polyvinyl ester, polysulfonate, polysulfide, polythioester, polysulfone, polysulfonamide, polyurea, polyphosphazene, polysilazane, or a combination thereof.

The coating resin can comprise a curable resin, for example a polyacrylic, polyacrylate, epoxy, phenolic, polyurethane precursor, in particular polyurethane prepolymer, or combination thereof. Such resins are often used in combination with hardeners, for example a polyisocyanate or polyurethane prepolymer containing isocyanate groups. The prepolymer can then be reacted with monomers, oligomers, or polymers containing active hydrogen groups, for example hydroxyl and amino groups. These oligomers or polymers can be a polyester, polyacrylic, polyacrylate, or combination thereof. Curing agents can further be included, for example a short-chain diamine or glycol such 1,4-butanediol. If desired, a catalyst can be included to promote the reaction between the isocyanate groups and the hydroxyl or amino groups.

In an embodiment, the coating resin may comprise, for example, a mono- or polyfunctional acrylate, such as butyl acrylate, ethylhexyl acrylate, norbornyl acrylate, butanediol diacrylate, hexanediol diacrylate, dipropylene glycol diacrylate, tripropylene glycol diacrylate, trimethylolpropane triacrylate, trimethylolpropane triethoxytriacrylate, pentaerythritol tetraethoxytriacrylate, pentaerythritol tetraethoxytetraacrylate, polyether acrylate, polyether acrylate, polyurethane acrylate, epoxy acrylate, dendritic polyester/ether acrylate, a polyurethane polymer and their precursors in the form of the polyisocyanate, polyol, polyurethane prepolymer, as capped prepolymer and as fully reacted polyurethanes in the form of a melt or solution, or a combination thereof. More specifically a polyol in the form of a polyether, e.g., polyethylene glycol 400, polyester, alkyd resin, polycarbonate, hydroxy-containing polyacrylate, polyisocyanate, polyurethane prepolymer, poly(meth)alkyl acrylate, a polyvinyl acrylate such as polyvinyl butyral, polyvinyl acetate and its copolymers, or a combination thereof may be used.

Use of a polyurethane, specifically an acrylic polyurethane, with a catalyst such as PPG product DFX 11, available from PPG Industries, of Strongsville, Ohio, is specifically mentioned. In an embodiment, the catalyst may comprise a polymerization product of 1,3-butanediol, 2-ethyl-2-(hydroxymethyl)-1,3-propanediol, and 5-isocyanato-1-(isocyanatomethyl)-1,3,3-trimethylcyclohexane; n-butyl acetate; heptan-2-one; 5-isocyanato-1-(isocyanatomethyl)-1,3,3-trimethylcyclohexane; and 3-isocyanatomethyl-3,5,5-trimethylcyclohexyl isocyanate.

The coating resin can be disposed on the abraded/treated and optionally activated surface by means known to a person skilled in the art, for example, by spraying, brushing, dipping, or brushing. Once deposited, the coating resin can be cured to provide a coated surface to refurbish the surface of the electronic device.

The curing may include heating the coating resin. The heating may include convection heating, microwave heating, or infra-red heating. The heating may comprise heating at about 30° C. to about 80° C., specifically at about 35° C. to about 70° C. Infra-red heating is specifically mentioned.

Depending on the curing conditions and the specific formulation of the coating resin, the curing time varies from a few minutes to a few hours. Specifically, the curing time may be about 5 minutes to about 100 hours, specifically about 10 minutes to about 75 hours, more specifically about 1 hour to about 50 hours.

The surface to be refurbished can comprise glass or other materials suitable for use in the surface of electronic device components. In one embodiment, the surface to be refurbished comprises glass. In another embodiment, the surface comprises alkali aluminosilicate. Corning Gorilla glass is specifically mentioned.

Also disclosed is a method of refurbishing a digitizer for an electronic device, the method comprising the foregoing method for refurbishing a surface.

Also disclosed is a refurbished component for an electronic device comprising a glass surface, and a polymerization product of a coating resin comprising metal oxide nanoparticles disposed on the glass surface, wherein the metal oxide nanoparticles comprise about 50% to about 99% by weight of an oxide of a Groups 12 to 14, or a combination thereof.

In an embodiment, the coating is directly disposed on the surface of the component for an electronic device. In another embodiment, the refurbished component may further comprise an activation layer disposed between the coating and the component surface of the electronic device. The electronic device may be a wireless device. The component may be a screen, a digitizer, a front case, or a rear case, for example.

Also disclosed is refurbished electronic device, the electronic device comprising a refurbished component as described herein.

In summary, a method of refurbishing a surface comprises: abrading a surface to be refurbished with an abrasive to remove a coating on the surface and provide an abraded surface; optionally firstly cleaning the abraded surface by contacting with a glass cleaner to provide a firstly cleaned surface; optionally secondly cleaning the firstly cleaned surface by contacting the firstly cleaned surface with a grease remover to provide a secondly cleaned surface; optionally contacting the first or the secondly cleaned surface with an activator to provide an activated surface; disposing a coating resin on the abraded and optionally activated surface; and curing the coating resin to provide a coated surface to refurbish the surface of the electronic device, wherein the coating resin comprises metal oxide nanoparticles comprising about 50% to about 99% by weight of an oxide of Groups 12 to 14, or a combination thereof.

In various embodiments, (i) the abrading comprises abrading with a diamond polishing compound; (ii) the diamond polishing compound comprises diamond having a mesh of about 600 to about 2000 grit; (iii) the diamond polishing compound comprises 1200 mesh diamond; (iv) the diamond polishing compound comprises diamond having a maximum particle size of 1 micrometer to 15 micrometers; (v) the abrading comprises abrading with aluminum oxide having a particle size of 5 to 80 micrometers using an abrasive jet machining system; (vi) the oxide of the metal oxide nanoparticles comprises an oxide of Zn, Al, Si, or a combination thereof; (vii) the oxide of the metal oxide nanoparticles further comprises a Group 2 element; (viii) the metal oxide nanoparticles comprise about 50% to about 99% by weight of aluminum oxide and about 0.1% to about 50% by weight of an oxide of Mg, Zn, Si, or a combination thereof; and/or (ix) the metal oxide nanoparticles comprise zinc oxide, aluminum oxide, magnesium aluminum oxide, or a combination thereof.

A method of refurbishing a surface can also comprise contacting a surface to be refurbished with an etching composition to provide a treated surface; optionally firstly cleaning the treated surface by contacting with a glass cleaner to provide a firstly cleaned surface; optionally secondly cleaning the firstly cleaned surface by contacting the firstly cleaned surface with a grease remover to provide a secondly cleaned surface; optionally contacting the firstly or the secondly cleaned surface with an activator to provide an activated surface; disposing a coating resin on the abraded and optionally activated surface; and curing the coating resin to provide a coated surface to refurbish the surface of the electronic device, wherein the coating resin comprises metal oxide nanoparticles comprising about 50% to about 99% by weight of an oxide of Groups 12 to 14, or a combination thereof.

In various embodiments, (i) the contacting a surface to be refurbished comprises: applying an etching composition to the surface to be refurbished; allowing the etching composition to reside for about 2 seconds to about 30 minutes; and removing the etching composition and a coating from the surface; (ii) the etching composition comprises a fluoride selected from sodium fluoride, potassium fluoride, ammonium fluoride, sodium bifluoride, potassium bifluoride, ammonium bifluoride, ammonium borofluoride, ammonium silicofluride, or a combination thereof; (iii) the etching composition further comprises an acid selected from acetic acid, citric acid, malic acid, succinic acid, phosphoric acid, hydrochloric acid, sulfuric acid, nitric acid, hydrofluoric acid, or a combination thereof; (iv) the fluoride is present in an amount of about 1 wt % to about 50 wt % and the acid is present in an amount of about 0.1 wt % to about 20 wt %, all based on the total weight of the etching composition; and/or (v) the etching composition is selected from a paste, a cream, a gel or a liquid.

Further, in various embodiments, (i) the removed coating is an oleophilic coating or an oleophobic coating; (ii) the glass cleaner comprises water and acetic acid; (iii) the grease remover comprises acetone, an alcohol; liquid carbon dioxide; an aldehyde; a formamide; a ketone; acetonitrile; a sulfoxide; a sulfone; a thiophene; an acetate; an amide; or a combination thereof; (iv) the grease remover comprises mineral spirits, aliphatic petroleum distillates, white spirits, naphtha, heptane, toluene or a combination thereof; (v) the activator comprises a silane; (vi) the activator comprises a reaction product of an epoxy silane and an amino silane having at least two amino groups; (vii) the activator comprises a carboxysilyl compound of the formula SiR₁R₂R₃R₄ wherein R₁ is a straight or branched chain substituted with a carboxyl group or a salt thereof, each R₂, R₃ and R₄ is independently a C1 to C12 alkoxy group, a C1 to C12 alkyl group, a C6 to C24 aryl group, halogen, or hydroxyl; (viii) the activator comprises N-[(3-trimethoxysilyl)propyl]ethylene-diamine triacetic acid trisodium salt; (ix) the activator comprises 2-oxo-N-(3-(triethoxysilyl)propyl)azepane-1-carboxamide; (x) the activator comprises a silica sol comprising a metal salt and a partial hydrolyzate of an alkoxysilane oligomer, wherein the metal salt is a metal organic acid salt or a metal carbonate of one or more of magnesium, calcium, strontium and barium, and wherein the alkoxysilane oligomer is tetraethoxysilane, tetrapropoxysilane, methyltriethoxysilane, dimethylmethoxysilane, phenyltriethoxysilane, chlorotrimethylsilane, vinyltriethoxysilane or aminopropyltriethoxysilane; (xi) the activator comprises an unsaturated-hydrocarbylamido-alkanesulfonic acid or a salt thereof; (xii) the contacting comprises spraying, dipping, roll coating, brush coating, or transfer coating, (xiii) the surface comprises glass; (xiv) the surface is a surface of a component for an electronic device; and/or (xv) the component is a screen, a digitizer, a front case, or a back case for a wireless device.

A refurbished component for an electronic device can comprise a glass surface, and a polymerization product of a coating resin comprising metal oxide nanoparticles disposed on the glass surface, wherein the metal oxide nanoparticles comprise about 50% to about 99% by weight of an oxide of a Groups 12 to 14, or a combination thereof.

With respect to the method to refurbish a surface or the refurbished component, (i) the metal oxide nanoparticles may be coated with a silane or siloxane selected from hexamethyldisiloxane, octamethyltrisiloxane, hexamethyl-cyclo-trisiloxane, octamethyl-cyclo-tetrasiloxane, dihydroxytetramethyldisiloxane, dihydroxyhexamethyltrisiloxane, dihydroxyoctamethyltetrasiloxane, α,ω-dihydroxypolysiloxanes, dihydrohexamethyltrisiloxane, dihydrooctamethyltetrasiloxane, α,ω-dihydropolysiloxanes, di(hydroxypropyl)hexamethyltrisiloxane, di(hydroxypropyl)octamethyltetrasiloxane, triethoxysilane, octadecyltrimethoxysilane, 3-(trimethoxysilyl)propyl methacrylates, 3-(trimethoxysilyl)propyl acrylates, 3-(trimethoxysilyl)methyl methacrylates, 3-(trimethoxysilyl)methyl acrylates, 3-(trimethoxysilyl)pethyl methacrylates, 3-(trimethoxysilyl)ethyl acrylates, 3-(trimethoxysilyl)pentyl methacrylates, 3-(trimethoxysilyl)pentyl acrylates, 3-(trimethoxysilyl)hexyl methacrylates, 3-(trimethoxysilyl)hexyl acrylates, 3-(trimethoxysilyl)butyl methacrylates, 3-(trimethoxysilyl)butyl acrylates, 3-(trimethoxysilyl)heptyl methacrylates, 3-(trimethoxysilyl)heptyl acrylates, 3-(trimethoxysilyl)octyl methacrylates, 3-(trimethoxysilyl)octyl acrylates, methyltrimethoxysilanes, methyltriethoxysilanes, propyltrimethoxysilanes, propyltriethoxysilanes, isobutyltrimethoxysilanes, isobutyltriethoxysilanes, octyltrimethoxysilanes, octyltriethoxysilanes, hexadecyltrimethoxysilanes, phenyltrimethoxysilanes, phenyltriethoxysilanes, tridecafluoro-1,1,2,2-tetrahydrooctyltriethoxysilanes, tetramethoxysilanes, tetraethoxysilanes, oligomeric tetraethoxysilanes, tetra-n-propoxysilanes, 3-glycidyloxypropyltrimethoxysilanes, 3-glycidyloxypropyltriethoxysilanes, 3-methacryloyloxypropyltrimethoxysilanes, vinyltrimethoxysilanes, vinyltriethoxysilanes, 3-mercaptopropyltrimethoxysilanes, 3-aminopropyltriethoxysilanes, 3-aminopropyltrimethoxysilanes, 2-aminoethyl-3-aminopropyltrimethoxysilanes, triamino-functional propyltrimethoxysilanes, N-(n-butyl)-3-aminopropyltrimethoxysilanes, 3-aminopropylmethyldiethoxysilanes, or a combination thereof; (ii) the coating resin further comprises a polymer selected from polyacetals, polyolefins, polyacrylics, polyacrylates, polycarbonates, polystyrenes, polyesters, polyamides, polyamideimides, polyarylates, polyarylsulfones, polyethersulfones, polyphenylene sulfides, polyvinyl chlorides, polysulfones, polyimides, polyetherimides, polytetrafluoroethylenes, polyetherketones, polyether etherketones, polyether ketone ketones, polybenzoxazoles, polyphthalides, polyanhydrides, polyvinyl ethers, polyvinyl thioethers, polyvinyl alcohols, polyvinyl ketones, polyvinyl halides, polyvinyl nitriles, polyvinyl esters, polysulfonates, polysulfides, polythioesters, polysulfones, polysulfonamides, polyureas, polyphosphazenes, polysilazanes, polyethylene terephthalate, polybutylene terephthalate, polyurethanes, ethylene propylene diene rubber (EPR), polytetrafluoroethylene, fluorinated ethylene propylene, perfluoroalkoxyethylene, polychlorotrifluoroethylene, polyvinylidene fluoride, or a combination thereof; and/or (iii) the coating resin further comprises a polymer selected from butyl acrylate, ethylhexyl acrylate, norbornyl acrylate, butanediol diacrylate, hexanediol diacrylate, dipropylene glycol diacrylate, tripropylene glycol diacrylate, trimethylolpropane triacrylate, trimethylolpropane triethoxytriacrylate, pentaerythritol tetraethoxytriacrylate, pentaerythritol tetraethoxytetraacrylate, polyether acrylate, polyether acrylate, polyurethane acrylates, epoxy acrylates, dendritic polyester acrylates, dendritic polyether acrylates, polyurethane polymers and their precursors in the form of the polyisocyanates, polyols, polyurethane prepolymers, or a combination thereof.

In various embodiments, (i) the coating is disposed directly on the surface; or (ii) the refurbished component further comprises an activation layer disposed between the surface and the coating; (iii) the electronic device is a wireless device; and/or the refurbished component is a screen, a digitizer, a front case, or a rear case.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A method of refurbishing a surface, the method comprising:
abrading a surface to be refurbished with an abrasive to remove a coating on the surface and provide an abraded surface;
optionally firstly cleaning the abraded surface by contacting with a glass cleaner to provide a firstly cleaned surface;
optionally secondly cleaning the firstly cleaned surface by contacting the firstly cleaned surface with a grease remover to provide a secondly cleaned surface;
optionally contacting the firstly or the secondly cleaned surface with an activator to provide an activated surface;
disposing a coating resin on the abraded and optionally activated surface; and
curing the coating resin to provide a coated surface to refurbish the surface,
wherein the coating resin comprises metal oxide nanoparticles comprising about 50% to about 99% by weight of an oxide of Groups 12 to 14, or a combination thereof.

2. The method of claim 1, wherein the abrading comprises abrading with a diamond polishing compound.

3. The method of claim 2, wherein the diamond polishing compound comprises diamond having a mesh of about 600 to about 2000 grit.

4. The method of claim 3, wherein the diamond polishing compound comprises 1200 mesh diamond.

5. The method of claim 3, wherein the diamond polishing compound comprises diamond having a maximum particle size of 1 micrometer to 15 micrometers.

6. The method of claim 1, wherein the abrading comprises abrading with aluminum oxide having a particle size of 5 to 80 micrometers using an abrasive jet machining system.

7. The method of claim 1, wherein the an oxide of the metal oxide nanoparticles comprises an oxide of Zn, Al, Si, or a combination thereof.

8. The method of claim 7, wherein the oxide of the metal oxide nanoparticles further comprises a Group 2 element.

9. The method of claim 8, wherein the metal oxide nanoparticles comprise about 50% to about 99% by weight of aluminum oxide and about 0.1% to about 50% by weight of an oxide of Mg, Zn, Si, or a combination thereof.

10. The method of claim 7, wherein the metal oxide nanoparticles comprise zinc oxide, aluminum oxide, magnesium aluminum oxide, or a combination thereof.

11. A method of refurbishing a surface, the method comprising:
contacting a surface to be refurbished with an etching composition to provide a treated surface;
optionally firstly cleaning the treated surface by contacting with a glass cleaner to provide a firstly cleaned surface;
optionally secondly cleaning the firstly cleaned surface by contacting the firstly cleaned surface with a grease remover to provide a secondly cleaned surface;
optionally contacting the firstly or the secondly cleaned surface with an activator to provide an activated surface;
disposing a coating resin on the treated and optionally activated surface; and
curing the coating resin to provide a coated surface to refurbish the surface,
wherein the coating resin comprises metal oxide nanoparticles comprising about 50% to about 99% by weight of an oxide of Groups 12 to 14, or a combination thereof.

12. The method of claim 11, wherein the contacting a surface to be refurbished comprises:
applying an etching composition to the surface to be refurbished;
allowing the etching composition to reside for about 2 seconds to about 30 minutes; and
removing the etching composition and a coating from the surface.

13. The method of claim 12, wherein the etching composition comprises a fluoride selected from sodium fluoride, potassium fluoride, ammonium fluoride, sodium bifluoride, potassium bifluoride, ammonium bifluoride, ammonium borofluoride, ammonium silicofluride, or a combination thereof.

14. The method of claim 13, wherein the etching composition further comprises an acid selected from acetic acid, citric acid, malic acid, succinic acid, phosphoric acid, hydrochloric acid, sulfuric acid, nitric acid, hydrofluoric acid, or a combination thereof.

15. The method of claim 14, wherein the fluoride is present in an amount of about 1 wt % to about 50 wt % and the acid is present in an amount of about 0.1 wt % to about 20 wt %, each based on a total weight of the etching composition.

16. The method of claim 13, wherein the etching composition is selected from a paste, a cream, a gel or a liquid.

17. The method of claim 1, wherein the removed coating is an oleophobic coating.

18. The method of claim 1, wherein the removed coating is an oleophilic coating.

19. (canceled)

20. (canceled)

21. The method of claim 1, wherein the activator comprises a silane.

22. The method of claim 21, wherein the activator comprises a reaction product of an epoxy silane and an amino silane having at least two amino groups.

23. The method of claim 21, wherein the activator comprises a carboxysilyl compound of the formula SiR₁R₂R₃R₄ wherein R₁ is a straight or branched chain substituted with a carboxyl group or a salt thereof, and each R₂, R₃ and R₄ is independently a C1 to C12 alkoxy group, a C1 to C12 alkyl group, a C6 to C24 aryl group, halogen, or hydroxy.

24. The method of claim 21, wherein the activator comprises N-[(3-trimethoxysilyl)propyl]ethylene-diamine triacetic acid trisodium salt.

25. The method of claim 21, wherein the activator comprises 2-oxo-N-(3-(triethoxysilyl)propyl)azepane-1-carboxamide.

26. The method of claim 21,
wherein the activator comprises a silica sol comprising a metal salt and a partial hydrolyzate of an alkoxysilane oligomer,
wherein the metal salt is a metal organic acid salt or a metal carbonate of magnesium, calcium, strontium, barium, or a combination thereof, and
wherein the alkoxysilane oligomer is tetraethoxysilane, tetrapropoxysilane, methyltriethoxysilane, dimethylmethoxysilane, phenyltriethoxysilane, chlorotrimethylsilane, vinyltriethoxysilane, aminopropyltriethoxysilane, or a combination thereof.

27. The method of claim 21, wherein the activator comprises an unsaturated hydrocarbylamido-alkanesulfonic acid or a salt thereof.

28. (canceled)

29. (canceled)

30. (canceled)

31. (canceled)

32. (canceled)

33. The method of claim 11, wherein the surface is a surface of a component for an electronic device.

34. The method of claim 33, wherein the component is a screen, a digitizer, a front case, or a back case for a wireless device.

35. A refurbished component for an electronic device comprising:
a glass surface; and
a polymerization product of a coating resin comprising metal oxide nanoparticles disposed on the glass surface,
wherein the metal oxide nanoparticles comprise about 50% to about 99% by weight of an oxide of a Groups 12 to 14, or a combination thereof.

36. (canceled)

37. (canceled)

38. (canceled)

39. (canceled)

40. The refurbished component of claim 35, further comprising an activation layer disposed between the surface and the coating.

41. The refurbished component of claim 35, wherein the electronic device is a wireless device.

42. (canceled)

43. A refurbished electronic device, wherein the refurbished electronic device comprises a refurbished component of claim 35.
